(19) United States
(12) Patent Application Publication
(10) Pub. No.: US 2006/0138764 A1
(43) Pub. Date: Jun. 29, 2006

(54) Front-end vehicle structure

(76) Inventors: Georg Stefan Hagemann, Stuttgart (DE); Oliver Schmid, Besigheim (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/535,827

(22) PCT Filed: Oct. 18, 2003
(86) PCT No.: PCT/EP03/11514

§ 371 Date: Nov. 4, 2005

(30) Foreign Application Priority Data
Nov. 23, 2002 (DE) 102 54 693.2

(51) Int. Cl. B62D 21/00; B60R 27/00

(52) U.S. Cl. 280/781; 180/311; 296/203.02

(57) ABSTRACT

A front-end vehicle structure for a motor vehicle, in particular for a commercial vehicle, includes two longitudinal members and two crash box elements. It is essential to the invention that two connecting members are provided which each connect one of the longitudinal members to the associated crash box, element. Each of the connecting members is assembled from an inner shell, an upper shell, and a lower shell. In each case, the upper shell and the lower shell reinforce the inner shell.

### BACKGROUND AND SUMMARY OF THE INVENTION

This invention relates to a front-end vehicle structure for a motor vehicle, in particular for a commercial vehicle.

Commercial vehicles of conventional design are generally constructed in such a manner that two frame longitudinal members are connected to frame cross members and in such a manner form the supporting frame, the frame longitudinal members being brought as far as a front and/or a rear bumper and generally being connected to an end cross member and the bumper via a crash box part. Particularly in the region of the front end, the supporting frame, in addition to the supporting function as a frame component, also has to ensure an integrating function, for example for receiving the front axle and the drive unit.

On account of the components which are adapted to the particular overall weight and are intended for optimizing the payload capacity, the components differ greatly in dimensions, depending on the vehicle type. This different dimensioning results in complex components, the production of which is associated with high costs.

German document DE 42 40 344 A1 discloses an auxiliary frame for a truck chassis. The auxiliary frame is intended to cover various chassis frames in which an angled portion of the longitudinal members is situated at various locations. The auxiliary frame uses longitudinal members with a different profile in the longitudinal direction. In the front region, the longitudinal member has a U-profile and, in the remaining region, it has a Z-profile. The upper limb of the Z-profile adjoins the upper limb of the U-profile; by contrast, the lower limb of the Z-profile is offset in the transverse direction with respect to the lower limb of the U-profile, to be precise toward the adjacent longitudinal member. Thus, the offset, lower limbs of the Z-profiles of adjacent longitudinal members form a smaller clear width of the auxiliary frame, and the lower limbs of the U-profiles of adjacent longitudinal members form a larger clear width of the auxiliary frame. Different truck chassis can therefore be covered using one size of this auxiliary frame.

German document DE 40 06 418 A1 discloses a supporting frame for a truck. The supporting frame essentially comprises frame longitudinal members and frame cross members and also a spherical or composite link axle. Furthermore, it has a front cross member which extends beyond the ends of the longitudinal members over the width of the vehicle, is arranged at a distance from the bumper and is designed as the front-end vehicle module. On its side facing the center of the vehicle, the front-end vehicle module is connected to the ends of the frame longitudinal member and on its side facing in the direction of travel is connected to the bumper. The crank or composite link axle is mounted on the front-end vehicle module in such a manner that its angled portion engages around the end of the engine.

As a result of different wheel bases, the arrangement of leading or trailing axles and different heights of the frame longitudinal members, a multiplicity of variations of the commercial vehicle does not arise until the construction stage. The front-end vehicle module per se can be pre-assembled in relatively large piece numbers and stored, and thus enables conveyor line assembly.

German document DE 42 28 314 A1 discloses a chassis for a truck. The supporting structure of a truck which comprises a front end and a rear end is in three parts and comprises a central supporting framework, a bow-shaped front frame and a frame longitudinal member structure supporting the superstructures. The central supporting framework engages around the drive units and is essentially arranged in the complete shadow of the front wheels. Furthermore, it has a downwardly open, pannier-like shape. On its rear side, the central supporting framework is connected fixedly, but releasably, to the frame longitudinal member structure supporting the superstructures and, on its front side, is connected to a front, bow-shaped front frame which partially supports the driver cab and supports the front parts. In this manner, different rear ends can be adapted to the front end, which is always standard, even with the frame longitudinal member structure differing in height. However, nothing is disclosed in German document DE 42 28 314 A1 concerning structural details of the front end.

U.S. Pat. No. 6,328,377 B1 discloses a front-end vehicle structure of the type mentioned at the beginning which has two longitudinal members and two crash box elements. Furthermore, two connecting members are provided which each connect one of the longitudinal members to the associated crash box element. The connecting members can be assembled in each case from an inner part and, in order to reinforce the inner part, from an upper part and a lower part. In the case of the known front-end vehicle structure, the inner part is formed by a hollow profile while the lower part and upper part are in each case formed by an L-profile. In this case, the L-profiles completely engage around the circumference of the hollow profile.

U.S. Pat. No. 5,913,565 discloses a further front-end vehicle structure, in which, on each side of the vehicle, a connecting member connects a longitudinal member to a crash box element. In this case, the connecting members are in each case formed by a multipart hollow profile which can be reinforced with the aid of a reinforcing profile. The reinforcing profile here is largely matched to the profile of the connecting member and is optionally arranged on the outside thereof or on the inside thereof.

Japanese document 10-287269 shows a wide front-end vehicle structure, in which a thin-walled, front extruded profile is connected in a connecting region to a rear, thick-walled extruded profile. In the connecting region, U-shaped or L-shaped or C-shaped reinforcing elements are fitted from below or from above in such a manner that the reinforcing elements engage laterally both over the front and the rear extruded profile in the connecting region. By this means, the connecting region can be effectively reinforced.

The present invention is concerned with the problem of providing an improved embodiment of a front-end vehicle structure and of thereby simplifying the production process.

This problem is solved by the subject matter of the invention. Advantageous embodiments are the subject matter of the dependent claims.

The invention is based on the general concept of designing a front-end vehicle structure for a motor vehicle, in particular for a commercial vehicle, in such a manner that the production of very complex components, such as, for example, a pre-assembleable front-end vehicle structure, is possible on the basis of simple sheet-metal geometries.

This is achieved by providing two connecting members which each connect one of the longitudinal members to the associated crash box element, the connecting members being assembled in each case from three parts, namely from an inner shell (inner part) and an upper shell (upper part or upper sheet-metal strip) and a lower shell (lower part or lower sheet-metal strip) which each reinforce the inner shell.

The inner shell, the upper shell and the lower shell or the inner part, the upper part and the lower part are expediently designed as bent sheet-metal parts, the upper shell and the lower shell being arranged essentially on the edge of the inner shell and transversely with respect to it.

The separation of the supporting structure into a plurality of sheet-metal parts means that the latter are to be deformed only as bent sheet-metal parts and are therefore simple to manufacture. In the blank, the components for the left and right connecting members are identical and have merely to be tilted in a mirror-inverted manner. This firstly results in a simplified production of the sheet-metal parts and secondly, by means of a simple bending operation, a drawing operation which is problematic in the case of thinner sheet-metal components and severely strains the material is avoided.

The invention affords further advantages if each connecting member is designed in a manner such that it can be pushed by its front end into the associated crash box element and/or by a rear end into the associated longitudinal member. The separation of the supporting structure in the region of a front axle makes it possible to influence the length of the vehicle by appropriately varying the length of the connecting members.

Furthermore, provision can be made for the connecting members and the longitudinal members each to have a C-profile and for an external size of the respective connecting member to correspond, in the assembled state, with an internal size of the respective longitudinal member. This simplifies the assembly of the front-end vehicle structure and, with respect to a subsequent transmission of force, such as, for example, a transmission of transverse forces, achieves significant advantages in comparison to conventional constructions.

One particularly advantageous refinement of the solution according to the invention is characterized in that the inner shell, the upper shell and the lower shell are connected by means of welds extending along the bent-over edge sections. Accordingly, a weld bead or weld seam runs along the bent-over edge sections of the inner shell, which edge sections run parallel to the upper or lower shell and bear extensively against it, and therefore closes a gap situated between or the upper shell or lower shell and the inner shell and thus prevents the particularly problematic gap corrosion. Since the supporting structure of the vehicle is exposed virtually without any protection to the spray water occurring under the vehicle, which water, particularly in the winter months, is additionally contaminated by chlorides, the quality and, in association therewith, the service life of the commercial vehicle is increased by the encircling weld bead.

One particularly favorable development of the solution according to the invention is characterized in that the inner shell, the upper shell and the lower shell can be formed with an identical and/or different sheet-metal thickness. Commercial vehicles are produced for a very wide variety of spheres of use, such as, for example, for transportation of heavy loads or for conveying people, and accordingly require supporting structures of differing thickness. Account is taken of this circumstance in a particularly favorable manner by the use of identical and/or different sheet-metal thicknesses for the formation of the connecting members. Thus, the use of thick metal sheets is favorable particularly for vehicles having high payloads, while for lighter vehicles smaller sheet-metal thicknesses are sufficient. This enables a flexible reaction to the demands imposed on the vehicles without having to undertake relatively great changes during the production process.

Provision can expediently be made for the edge sections to be designed in a manner such that they are separated from one another by means of incisions. The incisions on the inner shell bring about a simplification of the forming process, in which the edge sections of the inner shell are bent over at right angles. Since the bent-over edge sections are not arranged parallel to one another, the material without incisions would be subject to considerable drawing operations and therefore loads. These can be entirely avoided by the abovementioned incisions, which, in addition to the abovementioned simplification of the production process, also protects the material.

One advantageous development is that the front-end vehicle structure is designed in the region of the connecting members for receiving a rigid axle or an individual wheel suspension. Depending in each case on the subsequent intended use of the vehicle, whether, for example, as a construction site vehicle or as a bus, the solution according to the invention makes it possible to design the front-end vehicle structure in a flexible manner, thus permitting, for example, the installation of a rigid axle for heavy-duty vehicles and the installation of an individual wheel suspension for lighter vehicles.

Further important features and advantages of the invention emerge from the subclaims, from the drawings and from the associated descriptions of the figures with reference to the drawings.

It goes without saying that the features mentioned above and those which have yet to be explained below can be used not only in the respectively stated combination but also in different combinations or on their own without departing from the scope of the present invention.

Preferred exemplary embodiments of the invention are illustrated in the drawings and are explained in more detail in the description below, with the same reference numbers referring to identical or similar or functionally identical components.

### BRIEF DESCRIPTION OF THE DRAWINGS

FIG. 1 shows a perspective view of a front-end vehicle structure according to the invention with connecting members,

FIG. 2 shows a view similar to FIG. 1, but from a different perspective, and

FIG. 3 shows an exploded illustration of one of the connecting members.

### DETAILED DESCRIPTION OF THE INVENTION

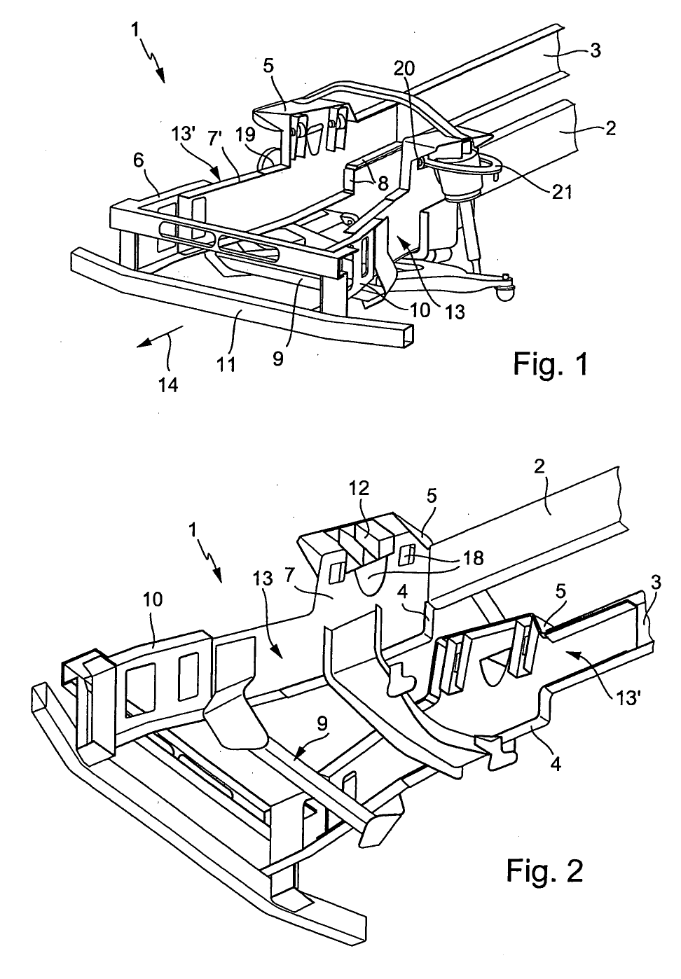

According to FIG. 1, a front-end vehicle structure 1 according to the invention shows two connecting members 13 and 13′ which extend essentially parallel to a vehicle longitudinal direction 14, which is symbolized by an arrow. The connecting members 13, 13′ are arranged upright between a rear end of a first crash box part 6 and a front end of a right longitudinal member 3, and between a rear end of a second crash box part 10 and a front end of a left longitudinal member 2 and are spaced apart from each other in the horizontal direction.

At a respective front end of the first crash box part 6 and of the second crash box part 10, said crash box parts are connected to each other in the transverse direction of the vehicle via a bumper 11. The connecting members 13, 13′ form a region of a subsequent front axle mount and are connected to each other in the transverse direction of the vehicle via a cross member 9. The connecting members 13, 13′ can be designed either for receiving a rigid axle or an individual wheel suspension.

In the region of the front-end vehicle structure 1 that is illustrated in FIG. 1 and FIG. 2, a driving device (not shown here) of the commercial vehicle is usually arranged between the two connecting members 13, 13′. A driving device of this type generally comprises an internal combustion engine and a transmission, for which reason the connecting members 13, 13′ are widened transversely with respect to the longitudinal direction 14 of the vehicle in the direction of a front end of the commercial vehicle.

The front-end vehicle structure 1 is constructed in a mirror-inverted manner with respect to a plane running vertically through the longitudinal center of the vehicle, with the result that just one half is described in detail below. However, the same accordingly applies for the other half.

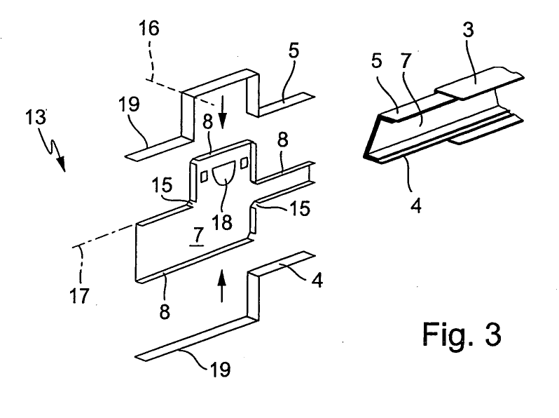

According to an exploded illustration in FIG. 3, the connection member 13 is composed of essentially three components.

These components comprise, firstly, an inner shell 7 which is positioned in an upright manner and has, on its upper and on its lower edge, respective edge sections 8 which are bent over at right angles to the plane of the shell and are angled in the direction of the abovementioned mirror plane about a buckling axis 17 running in the plane of the shell and parallel to the respective edge. The individual edge sections 8 are separated from one another by incisions 15 which have the effect that, during the bending operation, the material is bent only about one axis (cf. FIG. 3, number 17) and therefore multiaxial drawing operations which greatly strain the material are avoided.

Secondly, these components comprise an upper shell 5, which runs along parallel to the upper edge sections 8 and bears extensively against them and is connected hereto, and a lower shell 4, which runs along parallel to the lower edge sections 8, bears extensively against them and is connected hereto.

The upper shell 5 and the lower shell 4 are designed in each case as sheet-metal strips which are bent, corresponding to the respective edge sections 8 of the inner shell 7, about a plurality of bending axes 16 which are arranged parallel to one another and are spaced apart from one another and run orthogonally to the plane of the inner shell 7 and of which one is shown in FIG. 3 by way of example (cf. FIG. 3, number 16).

In this case, the upper shell 5 and the lower shell 4 are arranged on the inner shell 7 in such a manner that they bear parallel to the surface of the edge sections 8 of the inner shell 7 with a longitudinal edge 19 flush against the buckling axis 17 and, as a result, form a continuous, planar surface on the outside of the connecting member 13, which side faces away from the abovementioned mirror plane.

The upper shell 5 and the lower shell 4 are connected to the inner shell 7 in each case by means of welds which extend along the edge sections 8 and which, in a favorable manner, close a possibly occurring gap between the upper shell 5 and the inner shell 7 or the lower shell 4 and the inner shell 7 and therefore eliminate the risk of gap corrosion. At the same time, a weld bead arranged in an encircling manner is used to provide a fixed connection of the three shells 4, 5 and 7, which increases the rigidity of the connecting member 13.

According to FIG. 3, the assembled connecting member 13 is pushed into the longitudinal member 2 in such a manner that the open side of the C-shaped profile, which is formed by the inner shell 7 and the upper and lower shells 4, 5, point in the same direction, namely in the direction of the above-described mirror plane, in the case of the connecting member 13 and in the case of the longitudinal member 2.

In this case, the connecting member 13 is assembled in such a manner that it can be pushed into the longitudinal member 2 in a precisely fitting manner, as a result of which transverse forces and moments can be transmitted. That is to say, an external size of the connecting member 13 corresponds, in the assembled state, to an internal size of the left longitudinal member 2.

The connection between the connecting member 13 and the left longitudinal member 2 takes place, for example, by means of screw connections or welds (not illustrated in FIG. 3).

According to FIG. 2, a plurality of brackets 12 are arranged on the connecting member 13 or on the inner shell 7 and are designed for receiving a bearing 20 (illustrated in FIG. 1) of an upper transverse link 21 and for reinforcing the connecting member 13. The connection between the inner shell 7 and the brackets 12 likewise takes place, for example, by means of screw connections, rivet connections or welds.

According to FIG. 3, the inner shell 7 has a plurality of cutouts 18 through which components of the underbody structure or of the transverse link 21 can be guided. An adaptation to different load situations, as occur in the case of different vehicle types and/or in the case of a different intended use of the vehicle, takes place in particular by varying the sheet-metal thickness of the individual shells 4, 5 and 7 and, if appropriate, of the brackets 12.

By separating the connecting member 13 into the three shells 4, 5 and 7 mentioned, it is possible to produce the latter individually as bent sheet-metal parts and therefore to manufacture them in a simple manner. Furthermore, the front-end vehicle structure 1 with the components which can be attached thereto forms a pre-assembleable unit which can be pre-assembled within the context of a pre-assembly operation and can be fastened to the longitudinal members 2, 3 or the crash box parts 6, 10 within the context of a final assembly operation.

In summary, the invention can essentially be characterized as follows:

The connecting member 13 is essentially composed of three components: the inner shell 7 which is positioned in an upright manner and has edge sections 8, which are bent over at right angles on the edge, and the upper and lower shells 4 and 5 which run along parallel to them and bear extensively against them.

The upper shell 5 and the lower shell 4 are connected to the inner shell 7 in each case by seams of welds which are closed in an encircling manner and extend along the edge sections 8, eliminate the risk of gap corrosion and increase the rigidity of the connecting member 13.

The assembled connecting member 13 can be pushed into the longitudinal member 2 in a precisely fitting manner and can be screwed or welded to the latter.

By separating the connecting member 13 into three components, namely the inner shell 7, the upper shell 5 and the lower shell 4, it is possible to produce them as bent sheet-metal parts and to manufacture them in a simple manner without subjecting the material to a multidimensional drawing operation.

The front-end vehicle structure 1 can be designed optionally for receiving a rigid axle or an individual wheel suspension. An adaptation to different load situations expediently takes place by varying the sheet-metal thickness of the inner shell 7, the upper shell 5 and/or the lower shell 4 and the brackets 12.

1-9. (canceled)

10. A front-end vehicle structure for a motor vehicle, in particular for a commercial vehicle, comprising:
two longitudinal members,
two crash box elements, and
two connecting members, each of said connecting members connecting one of the longitudinal members to an associated one of the crash box elements,
wherein each of the connecting members is assembled from an inner part and, in order to reinforce the inner part, an upper part and a lower part,
wherein the inner part is an inner shell which is essentially positioned in an upright manner and has, at an upper end, bent-over, upper edge sections and, at a lower end, further bent-over, lower edge sections,
wherein the upper part is an upper sheet-metal strip which runs parallel to the upper edge sections, bears extensively against the upper edge sections, and is connected thereto, and
wherein the lower part is a lower sheet-metal strip which runs parallel to the lower edge sections, bears extensively against the lower edge sections, and is connected thereto.

11. The front-end vehicle structure as claimed in claim 10, wherein the inner part, the upper part, and the lower part are designed as bent sheet-metal parts, and wherein the upper part and the lower part are arranged essentially on an edge of the inner part and transversely thereto.

12. The front-end vehicle structure as claimed in claim 10, wherein each of the connecting members is designed so that it can be pushed by its front end into an associated one of the crash box elements, by its rear end into an associated one of the longitudinal members, or both by its front end into the associated one of the crash box elements and by its rear end into an associated one of the longitudinal members.

13. The front-end vehicle structure as claimed in claim 12, wherein each of the connecting members and the longitudinal members has a C-profile, and wherein an external size of each respective connecting member corresponds, in an assembled state, with an internal size of a respective one of the longitudinal members.

14. The front-end vehicle structure as claimed in claim 10, wherein the inner part, the upper part, and the lower part are connected by welds extending along the bent-over edge sections.

15. The front-end vehicle structure as claimed in claim 10, wherein the inner part, the upper part, and the lower part can be formed with identical or different sheet-metal thicknesses.

16. The front-end vehicle structure as claimed in claim 10, wherein the edge sections are separated from one another by incisions.

17. The front-end vehicle structure as claimed in claim 10, wherein the connecting members are reinforced by brackets, wherein one of said brackets is arranged on each inner part, and wherein each bracket is designed for reinforcing at least one of the connecting members.

18. The front-end vehicle structure as claimed in claim 10, wherein the front-end vehicle structure is designed, in a region of the connecting members, for receiving a rigid axle or an individual wheel suspension.

19. The front-end vehicle structure as claimed in claim 11, wherein each of the connecting members is designed so that it can be pushed by its front end into an associated one of the crash box elements, by its rear end into an associated one of the longitudinal members, or both by its front end into the associated one of the crash box elements and by its rear end into an associated one of the longitudinal members.

20. The front-end vehicle structure as claimed in claim 11, wherein the inner part, the upper part, and the lower part are connected by welds extending along the bent-over edge sections.

21. The front-end vehicle structure as claimed in claim 11, wherein the inner part, the upper part, and the lower part can be formed with identical or different sheet-metal thicknesses.

22. The front-end vehicle structure as claimed in claim 11, wherein the edge sections are separated from one another by incisions.

23. The front-end vehicle structure as claimed in claim 11, wherein the connecting members are reinforced by brackets, wherein one of said brackets is arranged on each inner part, and wherein each bracket is designed for reinforcing at least one of the connecting members.

24. The front-end vehicle structure as claimed in claim 11, wherein the front-end vehicle structure is designed, in a region of the connecting members, for receiving a rigid axle or an individual wheel suspension.

25. The front-end vehicle structure as claimed in claim 12, wherein the inner part, the upper part, and the lower part are connected by welds extending along the bent-over edge sections.

26. The front-end vehicle structure as claimed in claim 12, wherein the inner part, the upper part, and the lower part can be formed with identical or different sheet-metal thicknesses.

27. The front-end vehicle structure as claimed in claim 12, wherein the edge sections are separated from one another by incisions.

28. The front-end vehicle structure as claimed in claim 12, wherein the connecting members are reinforced by brackets, wherein one of said brackets is arranged on each inner part, and wherein each bracket is designed for reinforcing at least one of the connecting members.

29. The front-end vehicle structure as claimed in claim 12, wherein the front-end vehicle structure is designed, in a region of the connecting members, for receiving a rigid axle or an individual wheel suspension.
